(19) United States
(12) Patent Application Publication
(10) Pub. No.: US 2016/0012185 A1
(43) Pub. Date: Jan. 14, 2016

(54) PHONE AND TABLET APPLICATIONS FOR CARDIAC IMPLANTABLE ELECTRONIC DEVICES (MY PACER APP)

(71) Applicant: Adam Maxwell AU, Miami, FL (US)

(72) Inventor: Adam Maxwell AU, Miami, FL (US)

(73) Assignee: PHYSICIANS CREEK INC, Miami, FL (US)

(21) Appl. No.: 14/328,707

(22) Filed: Jul. 11, 2014

(51) Int. Cl. G06F 19/00

(52) U.S. Cl. CPC G06F 19/322

(57) ABSTRACT

In this era, secured electronic medical records are a given for medical decision making at point-of-care and continuity of care of patients. Multiple attempts are underway to pave way for a hundred percent use of electronic medical records. One such specialty paving the way is Cardiology; and the reason perhaps is the many life-saving devices that are used and the numerous data that are accumulated over time.

This invention concerns embedding patient data of cardiac implantable electronic devices, namely: pacemakers, defibrillators, combination of the these two devices, cardiac resynchronization therapy, implantable cardioverter defibrillators, and combination of this with a defibrillator into a phone and tablet application for ios, android and other phone platforms MY PACER APP.

### BACKGROUND OF INVENTION

In 1992 Computer-Based Patient Record Institute was assigned the responsibility to develop strategies for the adoption of computer based patient records. This initiative was further fortified in 1998 with the implementation of Health Insurance Portability and Accountability Act (HIPAA) in addressing issues regarding patient personal health information and privacy. In this era, the adoption of patient electronic medical records is the status quo in most health facilities, but with limitations, effectiveness and fragmentation.

Current patient health information records encompass areas of chief complaint, history of present illness, allergies, medications, social history, family history, surgical history, review of organ systems, physical examination, data, assessments, plan and comments. The data captured by medical records in health institutions are specific to the illness of the patient and what specialty of care needed. Cardiology as a specialty relies heavily on numerous life saving cardiovascular devices and diagnostic testing for comprehensive patient care. It is clear that data collection regarding these devices become the basis for continuity of care and future medical decision making. Ambulatory form of data collection is often needed for the specialized patient care needs. However, there is a paucity of data availability regarding pacemakers, defibrillators, cardioverter-defibrillators, cardiac resynchronization therapy, and pacemaker/defibrillators (PM/ICD/CRT/D/PM-D/CRT-D) at patient point of care. In the present generation it so happens that phones and tablets have become extensions of laptops and desktop computers and their use more accessible to patient, doctors and providers; hence making them amenable to data storage and retrieval of data regarding the above-mentioned devices.

### THE PROBLEM AND BENEFITS

### Paucity of Health Data

### Clinical Case #1:

85 F with a recent fall was been admitted for hyponatremia 128. Review of medical records indicated that she had a pacer placed in the past. Now due to her symptomatic electrolyte imbalance she could not import any of the history regarding her cardiac implanted electrical device. Her EKG showed a paced rhythm of 68 bpm. After making orders for admission and sodium correction, the internist orders a pacemaker interrogation.

### Clinical Case #2:

62M was admitted via the ER for emergent appendectomy at 2 in the morning. Pre-operative assessment indicated the presence of an implanted device which was judged by history and size to be a ICD. Even though the operation had been done without any cardiovascular event, the surgeon had been upset that the anesthesiologist had taken too long during the pre-operative assessment of the implanted cardiac device.

### Clinical Case #3:

74M has had a DDD pacer for the last 8 years. The most recent times that it was checked had been the previous 6 months and another 6 months before that. His medical conditions include systemic arterial hypertension controlled on Losartan 100 mg daily. During this year's follow-up visit he reports medication compliance, he is alert and oriented and denies any complaints regarding syncope, presyncope, chest pain or palpitations. In this visit, the PCP ordered a pacer inetrrogation.

### Clinical Case #4:

Cardiac catheterization in 39 F with cardiomyopathy with ejection fraction of 25% was diagnostic for non-ischemic cardiovascular disease. Subsquently, she had not improved on a life vest after three months hence receiving a CRT. Post procedure, it had been eight months without any hint of her for follow up.

### Clinical Case #5:

58M had been consulted with the interrogation service for CRT-D check for recent recurrent palpitations. After the event, he had requested the technician to provide him with a copy of the interrogation record. After printing a hard copy to his chart; she had informed him that it would be looked by the cardiologist.

### CRITIQUE OF CLINICAL CASES

After the 20th century, elctronic health records are a given with the ultimate goal of eliminating and replacing all paper charts. Since the evolution of health informaion management systems, most governing bodies including the American Medical Association have had a stake in protecting patients' privacy and making available records available when needed for care. The case in 5 above raises many serious concerns in which paper charts by their inherent fragility can be damaged, lost or falsified. Instead, an electronic version as in this invention of phone and tablet applications would offer the advantage of easy accessibility to an expert such as an electrophysiologist or a cardiologist for management in complex cases where a techinician offering the interrogation is not able to do so.

Most providers and allied health professionals continue to implement a wide array of systems for durable health information systems. Nonetheless; there is still numerous cracks in this effort. Guidelines endorsed by American Heart Association and the American Colloege of Cardiology recommend a six month interval device check after the initail check post implantation; and then a yearly interrogation—also approved by the center of Center of Medicare and Medicaid Services in 1984. In spite of the guidelines, we providers are also aware that device interrogation can be on case-to-case basis where the availability of a most recent document as an archive source would not have helped with the core medical decision making or perhaps even obviated the need or usefulness of another interrogation as in case 3 cited above.

Even though the appendectomy in case number 2 above had been performed uneventfully, the inevitable preoperative delay due to lack of an immediate data source for the patient's cardiac implantable electrocal device leaves much to think about. The American Association of Anesthesiologist in its task force report 2011 requires its members to determine whether reprograming pacing function to asynchronous mode or disabling rate responsive function is advantageous for the specific procedure—an information that can only be acquired in a timely fashion when the data is available at the point of care. And among other recommendations; suspending antitatachyarrhythmia functions if present. To improve delivery in this situation is possible, but would hinge on an opportune data that is more accessible, better quality, easier to retrieve, captures data from a specific large database and enhances staff productivity as would be offered by phone and tablet applications

In a litigous medical environment, redundancy creeps into defensive medicine. It was later discovered that the patient in case #1 above had only recently about a month prior to this admission, had a battery change. Inability to narrate such pertinent personal medical history in vulnerable populations such as her is rampant and can only get worse with growing dementia in society. The Internist may have done the right thing by acting on the unknown in foreseeing a risk of possible mortality with device failure.

The patient is case number 5 was long overdue her ICD interrogation. The guidelines recommend follow up in six months after intial implantation. At this point we all come face-to-face with an unprecedented challenge for creating a formidable system that will perhaps go beyond just data protection and confidentiality, but also capturing information on tracking and follow-up both accessible to the patient and the provider as in PHONE AND TABLET APPLICATIONS FOR CARDIAC IMPLANTABLE ELECTRONIC DEVICES (MY PACER APP).

### SUMMARY

The present conventional and remote form of cardiac electronic device interrogation are effective, but with gaps in providing information at point of care hence the need for electronic medical record that is easily accessible as in a form of phone or tablet application.

1. Phone and Tablet Application (APPS) for secured Patient electronic medical record specific to:
PM, CRT, CRT-D, DF, ICD and combination devices.
